(19) United States
(12) Patent Application Publication
(10) Pub. No.: US 2009/0006521 A1
(43) Pub. Date: Jan. 1, 2009

(54) ADAPTIVE RECEIVE SIDE SCALING

(76) Inventors: Bryan E. Veal, Hillsboro, OR (US); Annie Foong, Hillsboro, OR (US)

Correspondence Address: INTEL CORPORATION;c/o INTELLEVATE, LLC, P.O. BOX 52050, MINNEAPOLIS, MN, 55402, US

(21) Appl. No.: 11/771,250

(22) Filed: Jun. 29, 2007

(51) Int. Cl. G06F 15/16

(52) U.S. Cl. 709/201

(57) ABSTRACT

Receive side scaling in a network system may be improved by moving the task of adapting the load distribution from the operating system (“OS”) to the network device. A load feedback mechanism may be used for the OS to report per-core load to the network device. With per-core load information from the OS as well as its own knowledge of new flows, the network device is able to map new flows to the least-utilized cores by changing these cores' entries in an indirection table in the network device directly.

### BACKGROUND

1. Field

This disclosure relates generally to computer network systems, and more specifically but not exclusively, to adaptive receive-side scaling technologies in a network system.

2. Description

As network speeds increase, it becomes necessary to scale packet processing across multiple processors in a system. For receive processing, a feature called RSS (Receive Side Scaling) can distribute incoming packets across multiple processors in a system. RSS is a Microsoft® Windows® operating system (“OS”) technology that enables receive-processing to scale with the number of available computer processors by allowing the network load from a network controller to be balanced across multiple processors. RSS is described in “Scalable Networking: Eliminating the Receive Processing Bottleneck—Introducing RSS”, WinHEC (Windows Hardware Engineering Conference) 2004, Apr. 14, 2004 (hereinafter “the WinHEC Apr. 14, 2004 white paper”). It is also scheduled to be part of the yet-to-be-released future version of the Network Driver Interface Specification (NDIS). NDIS describes a Microsoft™ Windows® device driver that enables a single network controller, such as a NIC (network interface card), to support multiple network protocols, or that enables multiple network controllers to support multiple network protocols. The current version of NDIS is NDIS 5.1, and is available from Microsoft® Corporation of Redmond, Wash. The subsequent version of NDIS, known as NDIS 5.2, available from Microsoft™ Corporation, is currently known as the “Scalable Networking Pack” for Windows Server 2003.

With the RSS feature, the OS distributes the processing load for network traffic across multiple processors, cores, or hardware threads (all of which will be referred to as “cores” for the convenience of description) by maintaining an indirection table in the network device that maps flows to cores. Currently, RSS only provides a means for the OS to update the network device's indirection table, but the OS has no way of knowing which entry of the indirection table a new flow will be mapped to. The OS can only react to load imbalance by either moving established flows or changing unused indirection table entries. Moving established flows in the indirection table requires a core-to-core migration of per-flow state, which may result in cache/TLB (Translation Look-aside Table) misses and/or packet reordering. Changing unused entries in the indirection table may not map new flows to an underutilized core with certainty. Therefore, it is desirable to have new techniques to better balance workload across multiple cores at the receive side of a network system.

### BRIEF DESCRIPTION OF THE DRAWINGS

The features and advantages of the disclosed subject matter will become apparent from the following detailed description of the subject matter in which:

FIG. 1 illustrates a computer system where an embodiment of the subject matter disclosed in the present application may be implemented;

FIG. 2 illustrates a network in which embodiments of the subject matter disclosed in the present application may operate;

FIG. 3 illustrates a system according to at least one embodiment of the subject matter disclosed in the present application;

FIG. 4 illustrates a block diagram of an apparatus which may be used to implement an embodiment of the subject matter disclosed in the present application;

FIG. 5 illustrates an example indirection table, according to an embodiment of the subject matter disclosed in the present application;

FIG. 6 shows pseudo code of an example process for updating the flow and burst registers when a packet arrives, according to an embodiment of the subject matter disclosed in the present application;

FIG. 7 is a table illustrating how an active flow register works, according to an embodiment of the subject matter disclosed in the present application;

FIG. 8 is a table illustrating how an active burst register works, according to an embodiment of the subject matter disclosed in the present application; and

FIG. 9 is a flowchart of an example process for adaptive receive side scaling directed by a network interface device, according to an embodiment of the subject matter disclosed in the present application.

### DETAILED DESCRIPTION

According to embodiments of the subject matter disclosed in this application, RSS may be improved by moving the task of adapting the load distribution from the OS to the network device. A load feedback mechanism may be used for the OS to report per-core load to the network device. With per-core load information from the OS as well as its own knowledge of new flows, the network device is able to map new flows to the least-utilized cores by changing these cores' entries in the indirection table directly. Additionally, an active flow register for each entry in the indirection table may be used to avoid remapping of active flows. If the processing load becomes too unbalanced despite efforts to map new flows to less-utilized cores, active burst registers may be used to provide a means for remapping only those flows which are between packet bursts, thus preventing costly packet reordering.

Reference in the specification to “one embodiment” or “an embodiment” of the disclosed subject matter means that a particular feature, structure or characteristic described in connection with the embodiment is included in at least one embodiment of the disclosed subject matter. Thus, the appearances of the phrase “in one embodiment” appearing in various places throughout the specification are not necessarily all referring to the same embodiment.

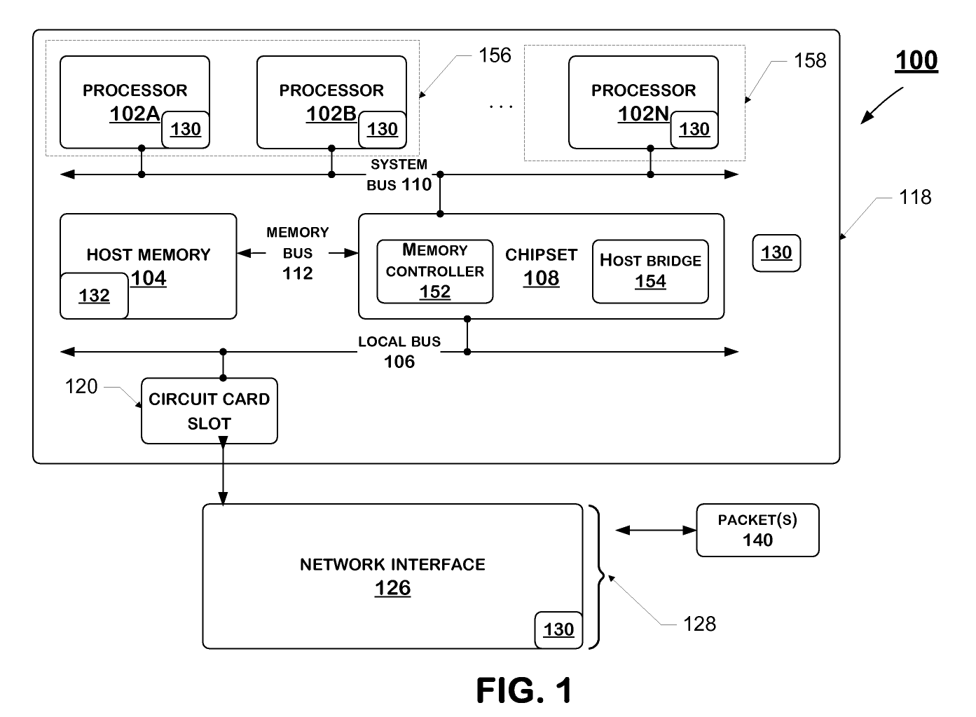

FIG. 1 illustrates a computer system 100 where an embodiment of the subject matter disclosed in the present application may be implemented. System 100 may comprise one or more processors 102A, 102B, . . . , 102N. A “processor” as discussed herein relates to a combination of hardware and software resources for accomplishing computational tasks. For example, a processor may comprise a system memory and processing circuitry (e.g., a central processing unit (CPU) or microcontroller) to execute machine-readable instructions for processing data according to a predefined instruction set. Alternatively, a processor may comprise just the processing circuitry (e.g., CPU). Another example of a processor is a computational engine that may be comprised in a multi-core processor, for example, where the operating system may perceive the computational engine as a discrete processor with a full set of execution resources. However, these are merely examples of processor and embodiments of the present invention are not limited in this respect.

Each processor 102A, 102B, . . . , 102N may be a coprocessor. In an embodiment, one or more processors 102A, 102B, . . . , 102N may perform substantially the same functions. Each processor may be electronically coupled to a system motherboard 118 through a socket. Two or more processors may share a socket. For example, processor 102A and 102B may share a socket 156; while processor 102N may has its own socket 158. When two or more processors share a socket, they may also share a common cache.

System 100 may additionally comprise memory 104. Memory 104 may store machine-executable instructions 132 that are capable of being executed, and/or data capable of being accessed, operated upon, and/or manipulated. “Machine-executable” instructions as referred to herein relate to expressions which may be understood by one or more machines for performing one or more logical operations. For example, machine-executable instructions may comprise instructions which are interpretable by a processor compiler for executing one or more operations on one or more data objects. However, this is merely an example of machine-executable instructions and embodiments of the present invention are not limited in this respect. Memory 104 may, for example, comprise read only, mass storage, random access computer-accessible memory, and/or one or more other types of machine-accessible memories.

Chipset 108 may comprise one or more integrated circuit chips, such as those selected from integrated circuit chipsets commercially available from Intel® Corporation (e.g., graphics, memory, and I/O controller hub chipsets), although other one or more integrated circuit chips may also, or alternatively, be used. According to an embodiment, chipset 108 may comprise an input/output control hub (ICH), and a memory control hub (MCH), although embodiments of the invention are not limited by this. Chipset 108 may comprise a host bridge/hub 154 that may couple processor 102A, 102B, . . . , 102N, and host memory 104 to each other and to local bus 106. Chipset 108 may communicate with memory 104 via memory bus 112 and with host processor 102 via system bus 110. In alternative embodiments, host processor 102 and host memory 104 may be coupled directly to bus 106, rather than via chipset 108.

Local bus 106 may be coupled to a circuit card slot 120 having a bus connector (not shown). Local bus 106 may comprise a bus that complies with the Peripheral Component Interconnect (PCI) Local Bus Specification, Revision 3.0, Feb. 3, 2004 available from the PCI Special Interest Group, Portland, Oreg., U.S.A. (hereinafter referred to as a “PCI bus”). Alternatively, for example, bus 106 may comprise a bus that complies with the PCI Express™ Base Specification, Revision 1.1, Mar. 28, 2005 also available from the PCI Special Interest Group (hereinafter referred to as a “PCI Express bus”). Bus 106 may comprise other types and configurations of bus systems. System bus 110 may comprise a frond side bus (“FSB”), a links-based point-to-point connection system, or other types of interconnection systems.

System 100 may additionally comprise one or more network interfaces 126 (only one shown). A “network interface” as referred to herein relates to a device which may be coupled to a communication medium to transmit data to and/or receive data from other devices coupled to the communication medium, i.e., to send and receive network traffic.

For example, a network interface may transmit packets 140 to and/or receive packets 140 from devices coupled to a network such as a local area network. As used herein, a “packet” means a sequence of one or more symbols and/or values that may be encoded by one or more signals transmitted from at least one sender to at least one receiver. Such a network interface 126 may communicate with other devices according to any one of several data communication formats such as, for example, communication formats according to versions of IEEE (Institute of Electrical and Electronics Engineers) Std. 802.3 (CSMA/CD Access Method, 2002 Edition); IEEE Std. 802.11 (LAN/MAN Wireless LANS, 1999 Edition), IEEE Std. 802.16 (2003 and 2004 Editions, LAN/MAN Broadband Wireless LANS), Universal Serial Bus, Firewire, asynchronous transfer mode (ATM), synchronous optical network (SONET) or synchronous digital hierarchy (SDH) standards.

In an embodiment, network interface 126 may reside on system motherboard 118. In another embodiment, network interface 126 may be integrated onto chipset 108. Yet in another embodiment, network interface 126 may instead be comprised in a circuit card 128 (e.g., NIC or network interface card) that may be inserted into circuit card slot 120. Circuit card slot 120 may comprise, for example, a PCI expansion slot that comprises a PCI bus connector (not shown). PCI bus connector (not shown) may be electrically and mechanically mated with a PCI bus connector (not shown) that is comprised in circuit card 128. Circuit card slot 120 and circuit card 128 may be constructed to permit circuit card 128 to be inserted into circuit card slot 120. When circuit card 128 is inserted into circuit card slot 120, PCI bus connectors (not shown) may become electrically and mechanically coupled to each other. When PCI bus connectors (not shown) are so coupled to each other, logic 130 in circuit card 128 may become electrically coupled to system bus 1110.

System may comprise logic 130. Logic 130 may comprise hardware, software, or a combination of hardware and software (e.g., firmware). For example, logic 130 may comprise circuitry (i.e., one or more circuits), to perform operations described herein. For example, logic 130 may comprise one or more digital circuits, one or more analog circuits, one or more state machines, programmable logic, and/or one or more ASIC's (Application-Specific Integrated Circuits). Logic 130 may be hardwired to perform the one or more operations. Alternatively or additionally, logic 130 may be embodied in machine-executable instructions 132 stored in a memory, such as memory 104, to perform these operations. Alternatively or additionally, logic 130 may be embodied in firmware. Logic may be comprised in various components of system 100, including network interface 126, chipset 108, one or more processors 102A, 102B, . . . , 102N, and/or on motherboard 118. Logic 130 may be used to perform various functions by various components according to embodiments of the subject matter disclosed in the present application.

System 100 may comprise more than one, and other types of memories, buses, processors, and network interfaces. For example, system 100 may comprise a server having multiple processors 102A, 102B, . . . , 102N and multiple network interfaces 126. Processors 102A, 102B, . . . , 102N, memory 104, and busses 106, 110, 112 may be comprised in a single circuit board, such as, for example, a system motherboard 118, but embodiments of the invention are not limited in this respect.

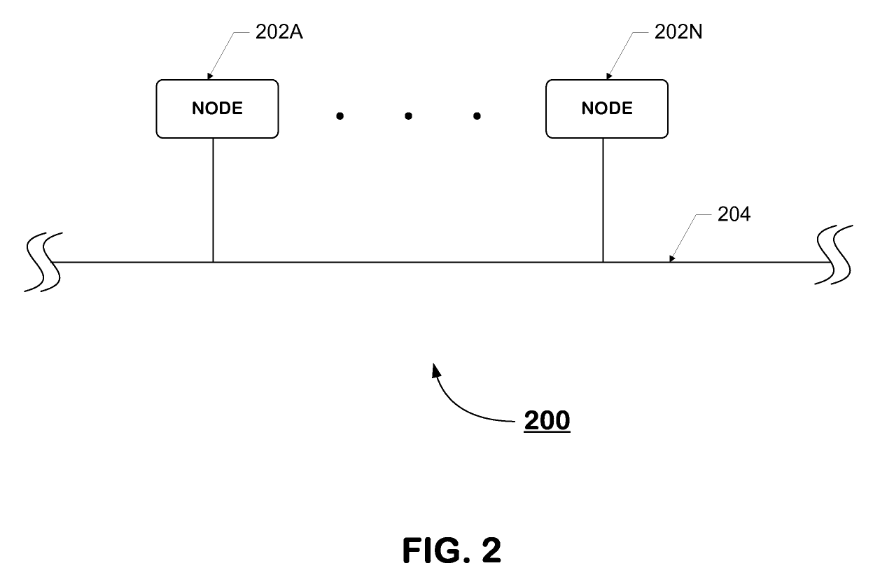

FIG. 2 illustrates a network 200 in which embodiments of the subject matter disclosed in the present application may operate. Network 200 may comprise a plurality of nodes 202A, . . . 202N, where each of nodes 202A, . . . , 202N may be communicatively coupled together via a communication medium 204. Nodes 202A . . . 202N may transmit and receive sets of one or more signals via medium 204 that may encode one or more packets. Communication medium 104 may comprise, for example, one or more optical and/or electrical cables, although many alternatives are possible. For example, communication medium 104 may comprise air and/or vacuum, through which nodes 202A . . . 202N may wirelessly transmit and/or receive sets of one or more signals.

In network 200, one or more of the nodes 202A . . . 202N may comprise one or more intermediate stations, such as, for example, one or more hubs, switches, and/or routers; additionally or alternatively, one or more of the nodes 202A . . . 202N may comprise one or more end stations. Also additionally or alternatively, network 200 may comprise one or more not shown intermediate stations, and medium 204 may communicatively couple together at least some of the nodes 202A . . . 202N and one or more of these intermediate stations. Of course, many alternatives are possible.

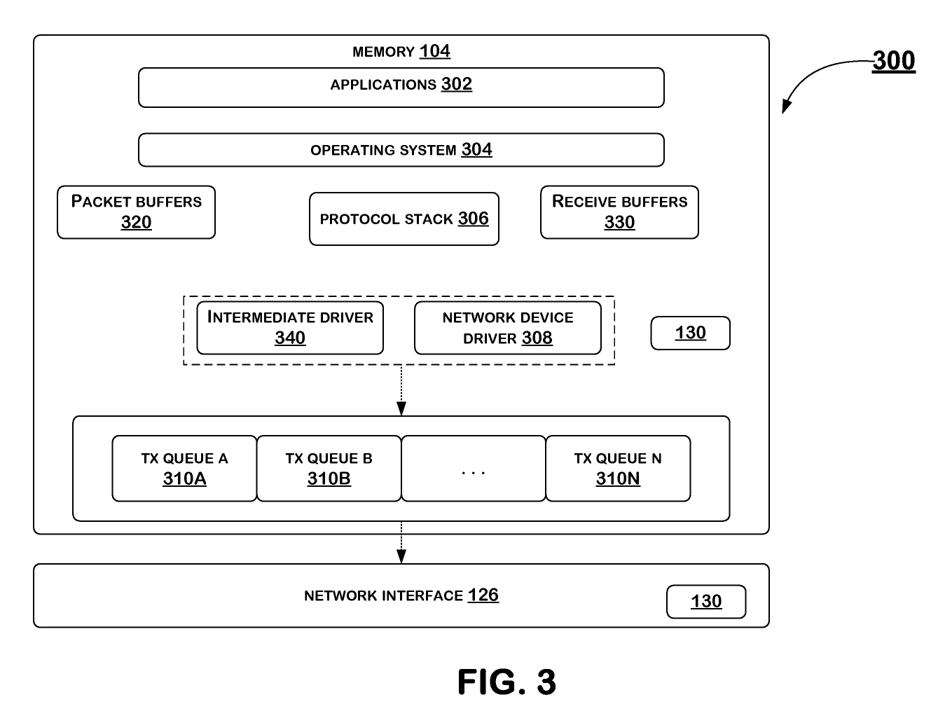

FIG. 3 illustrates a system 300 according to at least one embodiment of the invention. As illustrated in FIG. 3, memory 104 may host packet buffers 320, receive queues 330, device driver 308, operating system (OS) 304, intermediate driver 340, transmit queues (Tx queues) 310A-310N, and applications 302. Packet buffer 320 may include multiple buffers and each buffer may store at least one ingress packet received from a network. Packet buffer 320 may store packets received by network interface 126 that are queued for processing at least by device driver 308, operating system 304, intermediate driver 340, transmit queues (Tx queues) 310A-310N, and/or applications 302.

Receive queues 330 may include input queues and output queues. Input queues may be used to transfer descriptors from a processor (e.g., 102A), a memory (e.g., 104), or other storage coupled to the processor (e.g., a cache of the processor) to one or more network interfaces (e.g., network interface 126). A descriptor may be transferred to a single network interface. A descriptor may describe a location within a buffer and length of the buffer that is available to store an ingress packet. Output queues may be used to transfer return descriptors from any of network interfaces to a processor, a memory, or other storage coupled to the processor. A return descriptor may describe the buffer in which a particular ingress packet is stored within packet buffers 320 and identify features of the packet such as the length of the ingress packet, hash values and packet types, and checksum pass/fail. In one embodiment, receive queues 330 may include multiple input and multiple output queues. In one embodiment, where there are multiple network interfaces, intermediate driver 340 may allocate the receive queues associated with each of network interfaces for use by any of the network interfaces.

Device driver 308 may be device drivers for each of network interfaces (e.g., network interface 126). Although not depicted, in one embodiment, there may be a separate device driver for each of the multiple network interfaces. Device driver 308 may provide an interface between OS 304 and network interfaces (e.g., network interface 126). Device driver 308 may create descriptors and may manage the use and allocation of descriptors in receive queue 330. Device driver 308 may request transfer of descriptors to network interfaces using one or more input queues. Device driver 308 may signal to one of network interfaces that a descriptor is available on an input queue. Device driver 308 may determine the location of the ingress packet in packet buffer 320 based on a return descriptor that describes such ingress packet and device driver 308 may inform operating system 304 (as well as other routines and tasks) of the availability and location of such stored ingress packet.

Operating system 304 may manage system resources and control tasks that are run on system 100. For example, OS 304 may be implemented using Microsoft Windows, HP-UX, Linux, or UNIX, although other operating systems may be used. In one embodiment, OS 304 may be executed by each of the processors 110-0 to 110-N. In one embodiment, when a Microsoft Windows operating system is used, the ndis.sys driver may be utilized at least by device driver 304 and intermediate driver 340. For example, the ndis.sys driver may be utilized to define application programming interfaces (APIs) that can be used for transferring packets between layers. In one embodiment, OS 304 shown in FIG. 3 may be replaced by a virtual machine which may provide a layer of abstraction for underlying hardware to various operating systems running on one or more processors.

Operating system 304 may implement one or more protocol stacks 306 (only one shown). Protocol stack 306 may execute one or more programs to process packets 140. An example of a protocol stack is a TCP/IP (Transport Control Protocol/Internet Protocol) protocol stack comprising one or more programs for handling (e.g., processing or generating) packets 140 to transmit and/or receive over a network. Protocol stack 306 may alternatively be comprised on a dedicated sub-system such as, for example, a TCP offload engine.

In one embodiment, intermediate driver 340 may allocate the receive queues associated with each of network interfaces for use by any of the network interfaces so that network interfaces appear as a single virtual network interface with multiple receive queues to layers above intermediate driver 340 such as but not limited to OS 304. For example, for two network interfaces with two receive queues each, intermediate driver 340 may provide a single virtual network interface with four receive queues (e.g., four input and four output receive queues). Where multiple network interfaces are used, intermediate driver 340 allows taking advantage of features of OS 304 of directing packets for processing by a specific processor even when the device driver for one or any of network interfaces does not support use of multiple receive queues.

In addition to or as an alternative to providing load balancing of packet processing by processors, intermediate driver 340 may provide for load balancing of traffic received from a network via network interfaces. In one embodiment, intermediate driver 340 may provide for load balancing of traffic received from a network among network interfaces. For example, in one embodiment, intermediate driver 340 may include the capability to alter “ARP replies” (described in Ethernet standards) to request that traffic from a source device is thereafter addressed to a particular network interface among network interfaces for load balancing of packets received among network interfaces. Accordingly, packets thereafter may be transmitted from a source node to the selected network interface among network interfaces so that load balancing may take place among network interfaces. For example, intermediate driver 340 may use ARP replies to allocate a first connection for receipt at a first network interface and a second connection for receipt at a second network interface.

Tx queues 310A-310N may buffer data to be transmitted from an output port (for example, an input/output port or outlet) of a node (e.g., node 202A) to another node. If a network device driver only supports one Tx queue, the network device driver may have to acquire a spin lock on the single Tx queue and wait until other processors have released their locks on the Tx queue. The spin lock may result in lock contention which may degrade performance by requiring threads on one processor to “busy wait”, and unnecessarily increasing processor utilization, for example. Thus, many modern network device drivers support multiple Tx queues. Distribution of a packet among multiple Tx queues may be based on which processor generates the packet, type, class or quality of service associated with the packet, or data in the packet. Sometimes, even different frames within a packet may be distributed to different Tx queues based on type, class or quality of service associated with frames. In any case, if frames/packets of data are received at a node faster than the frames can be transmitted to another node, the Tx queue or queues begin to fill up with frames. Generally, recently received frames wait in the queue while frames received ahead of them in the queue are first transmitted.

Memory 104 may additionally comprise one or more applications 302 (only one shown). Applications 302 can be one or more machine executable programs that access data from a host system (e.g., 100) or a network. Application 302 may include, for example, a web browser, an email serving application, a file serving application, or a database application.

In a network system, typically only a small number of flows produce a large amount of traffic while a large number of flows produce a small amount of traffic. Thus, it is desirable for the number of flows to scale with the number processors in the system to adaptively balance the workload. With the RSS feature, an OS typically balance the workload by migrating flows from heavily loaded processors to the lightly loaded processors or changing unused indirection table entries hoping that new flows will end up there. However, these two approaches are not efficient in practice. Migrating a flow from one processor to another causes cache and TLB misses and packet reordering. Changing unused indirection table entries cannot map new flows to an underutilized processor with certainty.

According to an embodiment of the subject matter disclosed in the present application, logic 130 may be used to adaptively scale receive side flows without negative side effects of the above mentioned two approaches typically used by an OS. At least some components of logic 130 may be comprised in memory 104 and in network interface 126. These components along with other components in other parts of a network system together may improve RSS by moving the task of adaptive load distribution from the OS to the network interface device itself. This allows a flow placement decision to be made when the very first packet of a flow arrives, and before the packet is sent to a processor. Logic 130 may also cause flow migrations to occur between bursts. Since packets of a flow tend to travel in bursts and flow migration in the gaps between bursts helps prevent costly packet reordering. In contrast, the OS may not provide these types of adaptation because the OS only sees packets after their processor has been chosen and after the processing of the packets have already started.

The network interface device has immediate knowledge of new flows. If it also has sufficient load information, it may map new flows to the least-utilized processors by changing their indirection table entries directly. Assigning the first packet of a new flow to the least-utilized processor reduces the likelihood that the flow needs to be migrated. One way to provide the network interface device with the load information is using a load feedback mechanism for the OS to report per-core load to the network interface device.

Additionally, to avoid remapping of active flows, an active flow register may be introduced for each entry in the indirection table. Such an active flow register provides a way for the network interface device to mark a recently used table entry while allowing older entries to expire and to be remapped for new flows. In case the processing load becomes too unbalanced despite efforts to map new flows to less-utilized cores, active burst registers may be added to provide a means for remapping only those flows which are between packet bursts, thus preventing costly packet reordering.

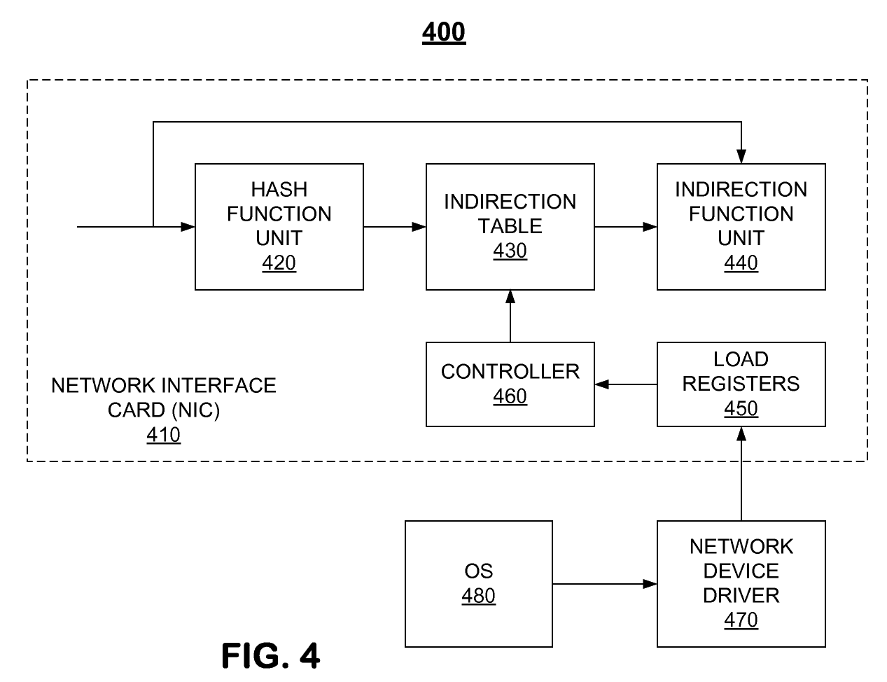

FIG. 4 illustrates a block diagram of an apparatus 400 which may be used to implement an embodiment of the subject matter disclosed herein. Apparatus 400 may comprise a hash function unit 420, an indirection table 430, an indirection function unit 440, load registers 450, a controller 460, a network device driver 470, and OS 480. In one embodiment, hash function unit 420, indirection table 430, indirection function unit 440, and load registers 450 may be included in a network interface card (“NIC”) 410. In another embodiment, some of these components or some elements of these components may be located outside an NIC. When a flow arrives in an NIC (e.g., NIC 410), the flow identity (“ID”) is first obtained. Normally a flow has an ID to identify itself. For example, the flow ID for a TCP packet may include a sequence of source IP address, destination IP address, source port number, and destination port number. This sequence uniquely identifies the flow to which the packet belongs. Support for other types of flow IDs and protocols is possible.

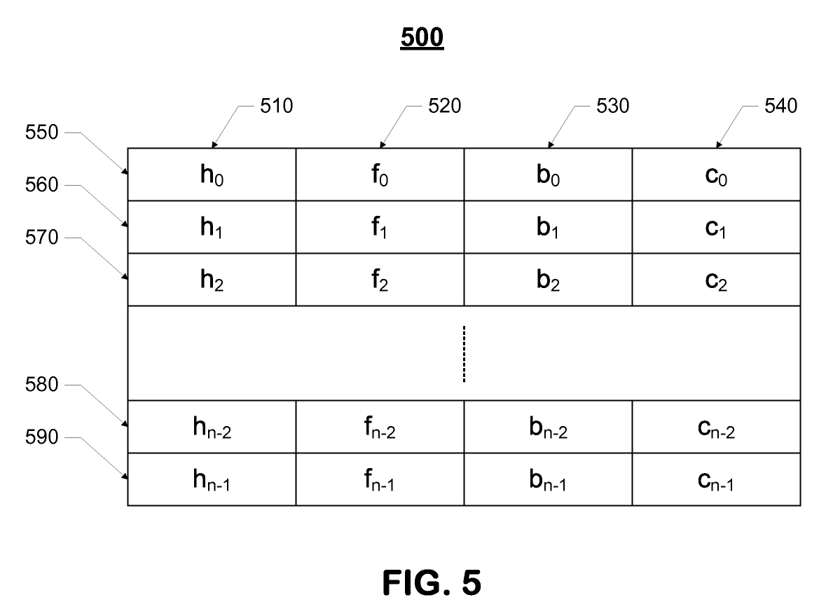

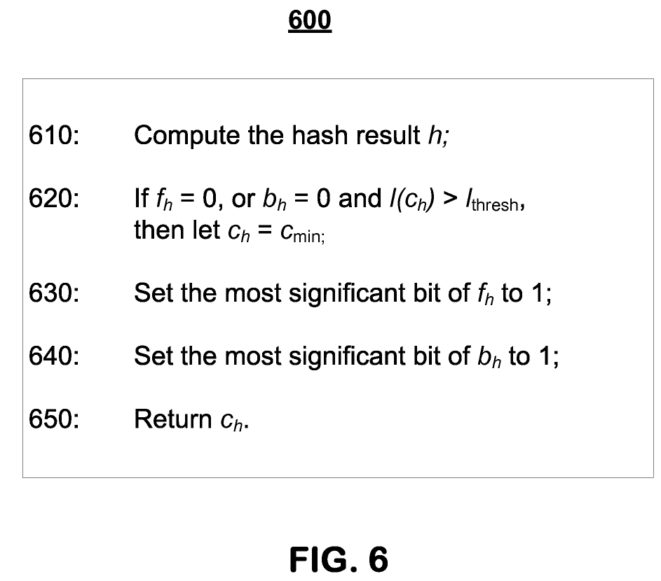

The flow ID is fed to hash function unit 420, which produces result h. The hash result h corresponds to one of entries in the indirection table. FIG. 5 illustrates an indirection table 500 which include four columns: column 510, column 520, column 530, and column 540. Column 510 includes hash results; column 520 includes information from active flow registers; column 530 includes information from active burst registers; and column 540 includes the identify information of a core to which the incoming packet is directed. Information stored in active flow registers and active burst registers may be controlled by a controller 460, which is described in more detail along with FIGS. 6-8.

Returning to FIG. 4, based on the hash result h, indirection table 430 returns the identify information of a core to which a packet of the incoming flow, which corresponds to the hash result h, is directed for processing. Indirection function unit 440 receives the identify information of the processing core and directs the packets of the flow to the processing core.

In a network system with the conventional RSS feature, OS 480 may directly change the values of the core identity information in indirection table 430 in response to the balance of load. According to an embodiment of the subject matter disclosed herein, the responsibility of load rebalancing may be moved from OS 480 to NIC 410. OS 480 may still provide load information of each core to NIC 410 through network device driver 470. For example, network device driver 470 may obtain core load information from a task scheduler of OS 480. Network device driver 470 may store the core load information in load registers 450, based on which controller 460 may update information in active flow registers and active burst registers in indirection table 430. According to an embodiment of the subject matter disclosed herein, the load feedback provided by OS 480 to NIC 410 may include core utilization, socket buffer queue utilization, descriptor ring utilization, a combination of the above, or some other metric(s). This load information may be stored in load registers on NIC 470. Using the load feedback, controller 460 in NIC 410 may make load balancing decisions based on migration threshold, lₜₕᵣₑₛₕ; the least loaded core, cₘᵢₙ; and load value of each core, <l₀, . . . , lₚ₋₁>. FIGS. 6-8 describe how this information is used. Network device driver 470 may write to load registers 450 periodically in response to a timer, or it may write to them as part of an interrupt service routine. Network device driver 470 sends the load feedback information frequently enough to prevent NIC 410 from overcompensating due to stale information.

As shown in FIG. 5, each entry in indirection table 500 includes an active flow register and an active burst register. Each register may store a bit vector that includes at least two bits. Bit vectors in flow and burst registers are updated under two circumstances-packet arrivals and periodic updates.

FIG. 6 shows pseudo code of an example process 600 for updating the flow and burst registers when a packet arrives, according to an embodiment of the subject matter disclosed herein. At line 610, hash function unit 420 may produce the indirection table entry h for a flow. At line 620, if the active flow register in the entry, fₕ, is unset (all bits are 0), or if the active burst register in entry h, bₕ, is unset and the load level of the core identified by cₕ, l(cₕ), is greater than some maximum load threshold, lₜₕᵣₑₛₕ, the flow may be distributed to the least utilized core cₘᵢₙ if it is a new one, and otherwise, the flow may be remapped to core cₘᵢₙ. Core may be identified cₘᵢₙ based on the load feedback information of each core, cₗ. If neither of the above two conditions is satisfied, cₕ is left alone. If fₕ is unset (all bits are 0), no packets have arrived recently that map to indirection table entry h and that the core ID, cₕ, may be freely changed. The flow may also be remapped if bₕ is unset, but only if l(cₕ) is greater than lₜₕᵣₑₛₕ. This allows an active flow to be remapped only when its core's load is too high, and only when enough time has elapsed since the previous packet arrival to avoid reordering packets.

At line 630, the most significant (leftmost) unset bit of fₕ is set; and at line 640 the most significant unset bit of bₕ is set. Setting the most significant bits of fh and bh denotes that a packet has arrived recently. At line 650, the ID of the core to which the flow is assigned or remapped, cₕ, may be returned. The load threshold lₜₕᵣₑₛₕ may be predetermined but need not be a constant value. It may change based on the potential for rebalancing (e.g., if the least loaded core is still heavily loaded).

In addition to updating bit vectors stored in the flow and burst registers upon packet arrivals, the bit vectors in these registers are updated periodically. During each periodic update, bits of the registers are shifted by one bit toward the least significant bit (right). The previous least significant bit is discarded and the new most significant bit is set to 0. Bit vectors in a flow register and a burst register in the same indirection table entry are updated at different intervals. The update intervals for the active burst and active flow registers may be preset to reasonable defaults which may be tuned through user interaction with a network device driver.

Some flows such as an active TCP flow could conceivably send their entire congestion window in one burst per round trip time (“RTT”). If an active flow register takes longer than the largest expected RTT to expire, packets for the flow may always be redirected to a particular core provided the core's load is reasonable. When the load of a core is too high, flows can migrate, but only when the active burst register has expired. Packet reordering may occur when packets from a single flow are processed on multiple cores. Thus, the active burst register should expire after enough time to allow all packets for a flow on one core to make their way through the packet input queue before directing packets to another core.

Typically, there should be at least two bits in the bit vector in each register. If there is only one bit in a bit vector, a packet could arrive immediately before an update and the register then expires immediately. A larger number of bits in the bit vector in an active flow register and an active burst register would increase the accuracy of timing flows and bursts.

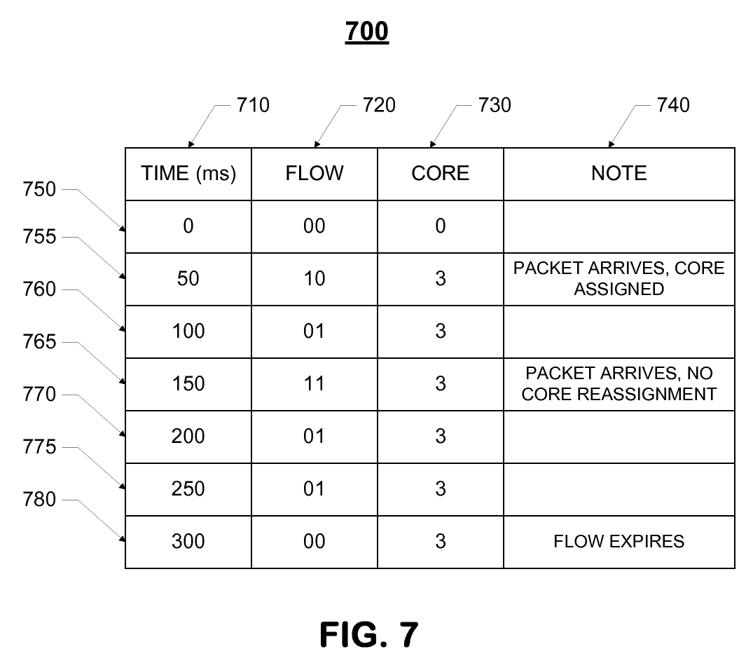

FIG. 7 is a table 700 illustrating how an active flow register works with a 100 ms update interval. In table 700, column 710 shows time marks; column 720 shows the bit vector in the active flow register; column 730 shows the core ID; and column 740 includes brief notes explaining how the bit vector in the active flow register changes. Row 750 shows how the active flow register is initially set at time 0 ms. Row 755 shows that the active flow register is unset when a packet of a flow arrives at time 50 ms. This shows that the packet is the first packet of the flow. The flow is assigned to the least utilized core such as core #3. Row 760 shows that at time 100 ms a periodic update is performed for the active flow register. The bit vector in the active flow register is shifted by one bit to the right. Row 765 shows at time 150 ms, the core will not be changed even if a new packet arrives because the least significant bit of the bit vector in the active flow register is still set showing that the flow is active and the packet is not for a new flow. However, the most significant bit of the bit vector is set due to the packet arrival. Row 770 shows that at time 200 ms a periodic update is performed for the active flow register. The bit vector in the active flow register is again shifted by one bit to the right. Row 775 shows that at time 250 ms, nothing occurs because no packet arrives and no periodic update is performed. Row 780 shows that at time 300 ms a periodic update is performed for the active flow register. As a result of the periodic update, the flow register expires and the next packet arrival can change to another core.

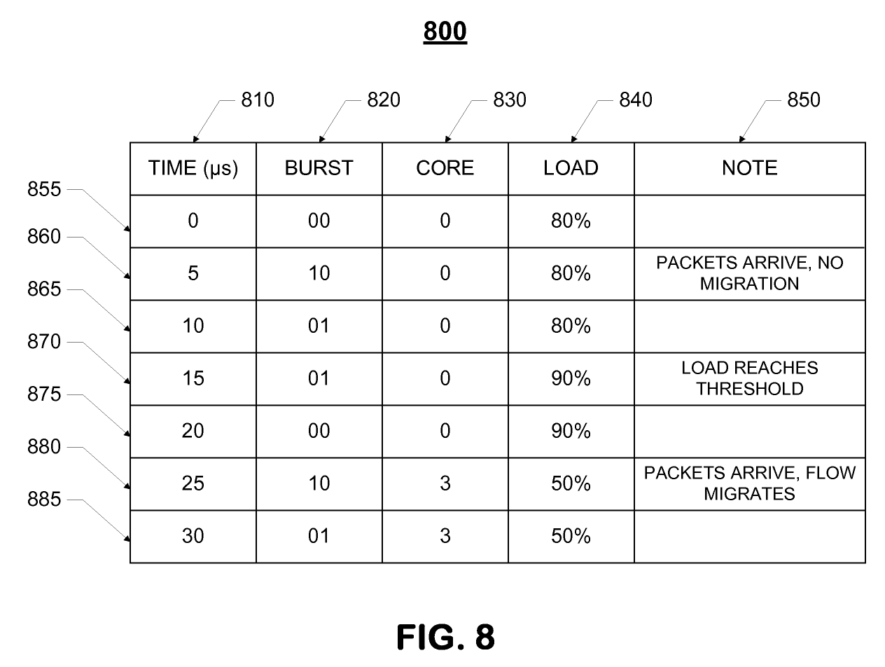

FIG. 8 is a table 800 illustrating how an active burst register works with a 10 μs update interval and lₜₕᵣₑₛₕ being 85%. In table 800, column 810 shows time marks; column 820 shows the bit vector in the active burst register; column 830 shows the core ID; column 840 shows the load information of a core; and column 850 includes brief notes explaining how the bit vector in the active burst register changes. Row 855 shows that the flow is initially assigned to core #0 at time 0 μs. Row 860 shows that the active burst register is unset when a packet of a flow arrives at time 5 μs. Since the load of the core #0 is still below lₜₕᵣₑₛₕ, the flow does not migrate to another core from core #0. Row 865 shows that at time 10 μs a periodic update is performed for the active burst register. The bit vector in the active burst register is shifted by one bit to the right. Row 870 shows at time 15 μs, the flow will not be remapped to another core even if the load of core #0 exceeds lₜₕᵣₑₛₕ because the least significant bit of the bit vector in the active burst register is still set showing that it is not a gap between burst at this time. Row 875 shows that at time 20 μs a periodic update is performed for the active burst register. The bit vector in the active burst register is again shifted by one bit to the right. As a result, the active burst register expires indicating that a gap occurs between bursts. Row 880 shows that at time 25 μs, the flow is migrated to core #3 because the load of core #0 exceeds the load threshold and the bit vector of the active burst register is not set. Row 885 shows that at time 30 μs a periodic update is performed for the active burst register. The bit vector in the active burst register is again shifted by one bit to the right.

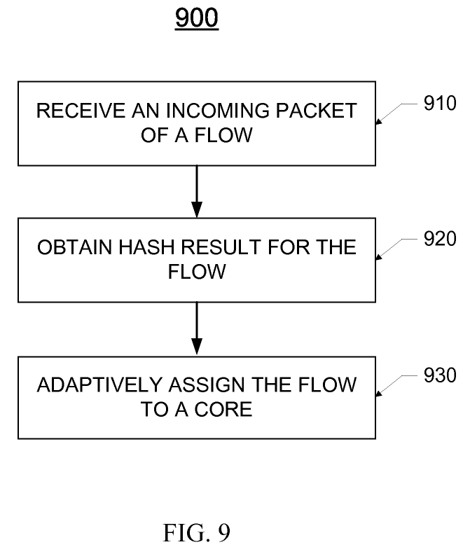

FIG. 9 is a flowchart of an example process 900 for adaptive receive side scaling directed by a network interface device, according to an embodiment of the subject matter disclosed in the present application. At block 910, the network interface device may receive a packet of a flow. At block 920, a hash result may be obtained based on the flow ID information in the packet. At block 930, the packet may be adaptively assigned to a core for processing by the network interface device. The network interface device may assign the packet to the processing core using the load feedback information from the OS and the information stored in active flow and active burst registers, according to what is disclosed above along with FIGS. 4-8.

Although an example embodiment of the disclosed subject matter is described with reference to drawings in FIGS. 1-9, persons of ordinary skill in the art will readily appreciate that many other methods of implementing the disclosed subject matter may alternatively be used. For example, the order of execution of the blocks in flow diagrams may be changed, and/or some of the blocks in block/flow diagrams described may be changed, eliminated, or combined.

In the preceding description, various aspects of the disclosed subject matter have been described. For purposes of explanation, specific numbers, systems and configurations were set forth in order to provide a thorough understanding of the subject matter. However, it is apparent to one skilled in the art having the benefit of this disclosure that the subject matter may be practiced without the specific details. In other instances, well-known features, components, or modules were omitted, simplified, combined, or split in order not to obscure the disclosed subject matter.

Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Program code may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine, and the medium may include a tangible medium through which electrical, optical, acoustical or other form of propagated signals or carrier wave encoding the program code may pass, such as antennas, optical fibers, communications interfaces, etc. Program code may be transmitted in the form of packets, serial data, parallel data, propagated signals, etc., and may be used in a compressed or encrypted format.

Program code may be implemented in programs executing on programmable machines such as mobile or stationary computers, personal digital assistants, set top boxes, cellular telephones and pagers, and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks may be performed by remote processing devices that are linked through a communications network.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

1. A method for adaptive receive side scaling in a network system, comprising:
receiving a packet of a flow by a network device;
obtaining a hash result for the flow; and
adaptively assigning the flow to one of a plurality of processing units by the network device based at least in part on load feedback information of each of the plurality of processing units.

2. The method of claim 1, wherein adaptively assigning the flow to one of the plurality of processing units comprises assigning the flow through an indirection table, the indirection table including a plurality of entries, each entry corresponding to a hash result and including a first register, a second register, and an identify of a processing unit to which a flow corresponding to the entry is assigned.

3. The method of claim 2, wherein adaptively assigning the flow to one of the plurality of processing units comprises updating values in the first register and the second register periodically.

4. The method of claim 2, wherein adaptively assigning the flow to one of the plurality of processing units comprises updating values in the first register and the second register when a packet arrives.

5. The method of claim 2, wherein adaptively assigning the flow to one of the plurality of processing units comprises assigning the flow to the least utilized processing unit if the value of a first register in the entry corresponding to the hash result of the flow is unset.

6. The method of claim 2, wherein adaptively assigning the flow to one of the plurality of processing units comprises remapping the flow to the least utilized processing unit if the value of an second register in the entry corresponding to the hash result of the flow is unset and the load of the processing unit that currently processes the incoming flow exceeds a threshold.

7. The method of claim 1, wherein the load feedback information of each of the plurality of processing units includes utilization of each of the plurality of processing units and is provided to the network device through a driver of the network device.

8. An apparatus for adaptive receive side scaling in a network system, comprising: a table, the table including a plurality of entries, each entry corresponding to a flow and including a first register, a second register, and an identity of a processing unit to which the flow is to be assigned; and
means for assigning an incoming flow to one of plurality of processing units based at least in part on values of a first register and a second register in an entry of the table corresponding to the incoming flow.

9. The apparatus of claim 8, further comprising a hash function unit to obtain a hash result for the incoming flow based at least in part on flow identity information in the incoming flow, the hash result being used to map the incoming flow to an entry in the table.

10. The apparatus of claim 8, further comprising at least one load register to store load feedback information of each of the plurality of processing units, the load feedback information including utilization of each of the plurality of processing units and is provided by an operating system through a network device driver.

11. The apparatus of claim 8, further comprising a controller to update a first register and a second register in an entry of the table when a packet of a flow arrives, the controller also updating the first register and the second register periodically.

12. The apparatus of claim 8, wherein the means for assigning an incoming flow assigns the incoming flow to the least utilized processing unit if the value of a first register in the entry corresponding to the incoming flow is unset.

13. The apparatus of claim 8, wherein the means for assigning an incoming flow remaps the incoming flow to the least utilized processing unit if the value of a second register in the entry corresponding to the incoming flow is unset and the load of the processing unit that currently processes the incoming flow exceeds a threshold.

14. The apparatus of claim 8, wherein the table and the means for assigning an incoming flow are comprised in a network device of a computing system.

15. A computing system with adaptive receive side scaling capability, comprising:
an operating system to manage workload of a plurality of processing units at the receive side of a network system; and
a driver of a network device to provide load feedback information of each of the plurality of the processing units from the operating system to the network device, the network device having:
a table, the table including a plurality of entries, each entry corresponding to a flow and including a first register, a second register, and an identity of a processing unit to which the flow is to be assigned, and
means for assigning an incoming flow to one of plurality of processing units based at least in part on values of a first register and a second register in an entry of the table corresponding to the incoming flow, the values of the first register and the second register being updated based at least in part on the load feedback information.

16. The computing system of claim 15, wherein the network device further comprises a hash function unit to obtain a hash result for the incoming flow based at least in part on flow identity information in the incoming flow, the hash result being used to map the incoming flow to an entry in the table.

17. The computing system of claim 15, wherein the network device further comprises at least one load register to store the load feedback information of each of the plurality of processing units, the load feedback information including utilization of each of the plurality of processing units.

18. The computing system of claim 15, wherein the network device further comprises a controller to update an first register and an second register in an entry of the table when a packet of a flow arrives, the controller also updating the first register and the second register periodically.

19. The computing system of claim 15, wherein the means for assigning an incoming flow assigns the incoming flow to the least utilized processing unit if the value of an first register in the entry corresponding to the incoming flow is unset.

20. The computing system of claim 15, wherein the means for assigning an incoming flow remaps the incoming flow to the least utilized processing unit if the value of a second register in the entry corresponding to the incoming flow is unset and the load of the processing unit that currently processes the incoming flow exceeds a threshold.
